(19) United States
(12) Patent Application Publication
(10) Pub. No.: US 2010/0177192 A1
(43) Pub. Date: Jul. 15, 2010

(54) THREE-DIMENSIONAL MEASURING DEVICE

(75) Inventor: Hiroyuki Ishigaki, Aichi (JP)

Correspondence Address: OSHA LIANG L.L.P., TWO HOUSTON CENTER, 909 FANNIN, SUITE 3500, HOUSTON, TX, 77010, US

(73) Assignee: CKD CORPORATION, Komaki-shi (JP)

(21) Appl. No.: 12/686,870

(22) Filed: Jan. 13, 2010

(30) Foreign Application Priority Data
Jan. 14, 2009 (JP) 2009-5265

(51) Int. Cl. H04N 7/18; G06K 9/40; G01B 11/14; G01B 11/24

(52) U.S. Cl. 348/135; 382/275; 356/625; 356/602; 348/E07.085

(57) ABSTRACT

A three-dimensional measuring device has an irradiation device that irradiates a light pattern having a striped light intensity distribution on a measurement object, an imaging device that images reflected light from the measurement object irradiated by the light pattern to obtain image data, an image processing device that performs measurement of height at various coordinate positions on the measurement object based on the image data imaged by the imaging device, and a correction calculation device that corrects of a distortion that occurs due to a field angle of a lens of the imaging device relative to height data and coordinate data of an measurement object point on the measurement object measured by the image processing device, by correction based on at least a height data of the imaging device and an irradiation angle data of the pattern light irradiated on the measurement object.

### CROSS-REFERENCE TO RELATED APPLICATIONS

This Application claims priority to Japanese Patent Application No. 2009-5265 filed on Jan. 14, 2009 in Japan.

### BACKGROUND OF INVENTION

1. Field of the Invention

The present invention generally relates to a three-dimensional measuring device.

2. Background Art

When an electronic component is mounted on a printed circuit board, a cream solder is generally first printed on a specific electrode pattern disposed on the printed circuit board. Adhesivity of this cream solder is then used to temporarily fix the electronic component on the printed circuit board. Thereafter, the above described printed circuit board is conveyed to a reflow furnace, and soldering is performed during a certain reflow step. Recently inspection of the printed state of the cream solder during stage prior to conveyance to the reflow furnace has been necessary, and three-dimensional measuring devices have been used during such inspection.

Various types of so-called non-contact type three-dimensional measuring devices using light have been proposed in recent years. Technology has been proposed which relates, for example, to three-dimensional measuring devices utilizing the phase shift method, space encoding method, or the like.

An imaging means, i.e. CCD camera or the like, is used in the three-dimensional measuring device of the above described technology. For example, when the phase shift method is used, an irradiation means combining a light source and a sine wave pattern filter is used to illuminate the measurement object (printed circuit board in this case) using a light pattern having a sinusoidal light intensity distribution. Thereafter, points on the substrate are measured using a CCD camera or the like disposed directly above the substrate. In this case, intensity I of light at a specific measurement object point in the image is given by the following equation:

I=e+f×cos(φ)

(within the formula, e=direct current optical noise (offset component), f=sine wave contrast (reflectivity), and φ=phase imparted by irregularities of the object).

Here, the pattern light is moved so that the phase changes, e.g. in four stages such as φ+0, φ+π/2, φ+π, and φ+3π/2. Images of the intensity distributions corresponding to these phase shift changes (i.e. I0, I1, I2, and I3, respectively) are captured, and the modulation component α is determined based on the below listed formula.

α=arctan{(I3−I1)/(I0−I2)}

This modulation component a is used to determine the three-dimensional coordinates (X, Y, Z) at a measurement object point on the printed circuit board (e.g. cream solder), and these three-dimensional coordinates are used to measure three-dimensional shape of the cream solder and especially to measure height of the cream solder.

However, due to field angle of the camera lens of the imaging means, in the field of three-dimensional measuring devices there are instances of such measured height data and coordinate data on the printed circuit board differing from the actual values. The basis of such differences will be explained below while referring to FIG. 4.

As described previously, pattern light H from a certain irradiation means is reflected the measurement object point, and this reflected light H′ is imaged by a camera 70. By this means, the three-dimensional measuring device, for example, is able sense a measurement object point A (X0, Z0) in the image plane (standard plane) M as a point located at a height Z0 (equal to zero) displaced by X0 from the image plane center O′.

In contrast, when reflected light H′ reflected from a measurement object point B (X1, Z1) having a height Z1 from the image plane M at a position displaced by X1 from the image plane center O′ enters the camera 70, the three-dimensional measuring device mistakenly senses this reflected light H′ as coming from a measurement object point C (X0, Z2) having a height Z2 at a position displaced by X0 from the image plane center O′. This results in a measurement error, and there is concern that this measurement error may invite a lowering of measurement accuracy.

In the field of three-dimensional measuring devices, telecentric optical systems have been used which have no distortion in the measured height data and coordinate data on the image plane according to height of the measurement object point (e.g., see Laid-open Patent Application No. 2003-527582).

### SUMMARY OF INVENTION

Telecentric optical systems may be large, costly, and have a narrow image field. One or more embodiments of the present invention provides a three-dimensional measuring device having excellent measurement accuracy without a telecentric optical system.

According to one or more embodiments of the present invention, a three-dimensional measuring device comprises an irradiation device that irradiates a light pattern having a striped light intensity distribution on a measurement object, an imaging device that images reflected light from the measurement object irradiated by the light pattern to obtain image data, an image processing device that performs measurement of height at various coordinate positions on the measurement object based on the image data imaged by the imaging device, and a correction calculation device that corrects of a distortion that occurs due to a field angle of a lens of the imaging device relative to height data and coordinate data of an measurement object point on the measurement object measured by the image processing device, by correction based on at least a height data of the imaging device and an irradiation angle data of the pattern light irradiated on the measurement object.

According to one or more embodiments of the present invention, improvement of measurement accuracy is possible, without use of a telecentric optical system, by calculation processing and software-based correction of the measurement data distortion which can occur due to the field angle of the lens of the imaging means. As a result, use becomes possible of a general macro lens and the like, and the imaging field can be widened. Thus, the increase in size, complexity of the device, and production cost can be suppressed.

According to one or more embodiments of the present invention, the imaging means is disposed directly above the measurement object, and the irradiation means is disposed obliquely above the measurement object.

According to one or more embodiments of the present invention, the imaging means is disposed directly above the measurement object and the irradiation means is disposed obliquely above the measurement object. Thus, the distortion of the measurement data, which can occur according to field angle of the lens of the imaging system, becomes large. The distortion can be correct according to one or more embodiments of the present invention.

According to one or more embodiments of the present invention, height Lco of the principle point of the lens of the imaging means relative to an image plane of the measurement object is used as the height data of the imaging means, an angle α between the image plane and a light beam of the pattern light irradiated from the irradiation means is used as the irradiation angle data of the pattern light, and the correction calculation means calculates a true coordinate data X0 and a true height data Z0 of the measurement object point from an apparent coordinate data X1 and an apparent height data Z1 of the measurement object point based on the formulae Z0=Lco×Z1/(Lco−X1×tan(α)), and X0={1−Z1/(Lco−X1×tan(α))}×X1.

According to one or more embodiments of the present invention, a three-dimensional measuring device comprises an irradiation device that irradiates a light pattern having a striped light intensity distribution on a measurement object, an imaging device that images reflected light from the measurement object irradiated by the light pattern to obtain image data, an image processing device that performs measurement of height at various coordinate positions on the measurement object based on the image data imaged by the imaging device, and a correction calculation device that corrects of a distortion that occurs due to a field angle of a lens of the imaging device relative to height data and coordinate data of an measurement object point on the measurement object measured by the image processing device, by correction based on at least a height data of the imaging device and an irradiation angle data of the pattern light irradiated on the measurement object.

According to one or more embodiments of the present invention, the imaging device is disposed directly above the measurement object, and the irradiation device is disposed obliquely above the measurement object.

According to one or more embodiments of the present invention, height Lco of the principle point of the lens of the imaging device relative to an image plane of the measurement object is used as the height data of the imaging device, an angle α between the image plane and a light beam of the pattern light irradiated from the irradiation device is used as the irradiation angle data of the pattern light, and the correction calculation device calculates a true coordinate data X0 and a true height data Z0 of the measurement object point from an apparent coordinate data X1 and an apparent height data Z1 of the measurement object point based on the formulae Z0=Lco×Z1/(Lco−X1×tan(α)), and X0={1−Z1/(Lco−X1×tan(α))}×X1.

According to one or more embodiments of the present invention, a three-dimensional measuring method comprises irradiating by an irradiating device a light pattern having a striped light intensity distribution on a measurement object, imaging by an imaging device reflected light from the measurement object irradiated by the light pattern to obtain image data, performing measurement of height at various coordinate positions on the measurement object based on the image data to obtain corresponding coordinate data and height data, and correcting a distortion that occurs due to a field angle of a lens employed in the imaging device relative to height data and coordinate data of an measurement object point on the measurement object, based on at least a height data of the imaging device and an irradiation angle data of the pattern light irradiated on the measurement object.

According to one or more embodiments of the present invention, a three-dimensional measuring method comprises disposing the imaging device directly above the measurement object; and disposing the irradiation device obliquely above the measurement object.

According to one or more embodiments of the present invention, height Lco of the principle point of the lens of the imaging device relative to an image plane of the measurement object is used as the height data of the imaging device, an angle α between the image plane and a light beam of the pattern light irradiated from the irradiation device is used as the irradiation angle data of the pattern light, and a true coordinate data X0 and a true height data Z0 of the measurement object point are calculated from an apparent coordinate data X1 and an apparent height data Z1 of the measurement object point based on the formulae Z0=Lco×Z1/(Lco−X1×tan(α)), and X0={1−Z1/(Lco−X1×tan(α))}×X1.

### BRIEF DESCRIPTION OF DRAWINGS

FIG. 1 is a simplified tilted perspective view that shows schematically the board inspection device according to one or more embodiments of the present invention.

FIG. 2 is a block diagram showing the electrical structure of the board inspection device according to one or more embodiments of the present invention.

FIG. 3 is a figure explaining the principles of calculation processing according to one or more embodiments of the present invention.

FIG. 4 is a figure explaining the principles of generation of distortion in measurement data due to field angle of the camera lens.

### DETAILED DESCRIPTION

Embodiments of the present invention are explained below, referring to the attached figures. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

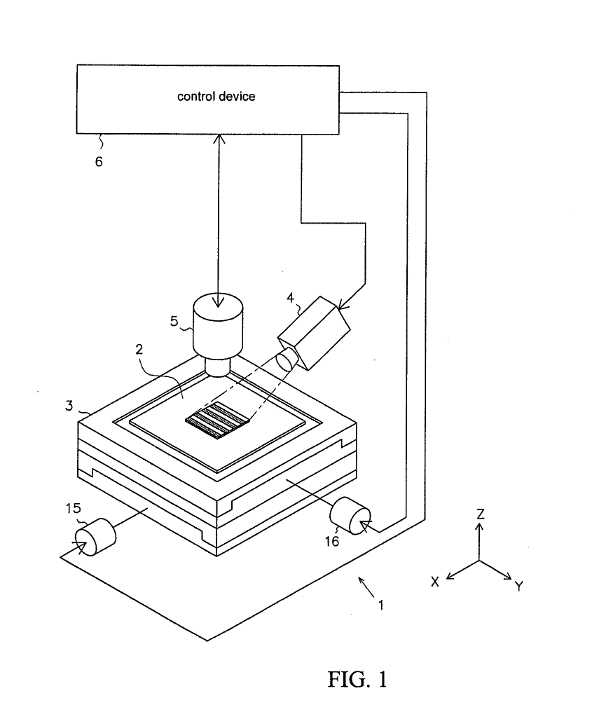

FIG. 1 is a simplified structural diagram showing schematically a board inspection device 1 equipped with the three-dimensional measuring device according to one or more embodiments of the present invention. As shown in FIG. 1, the board inspection device 1 includes a carrying base 3 for carrying a printed circuit board 2 as the measurement object printed using cream solder, an irradiation device 4 as an irradiation means for irradiation of a specific pattern light from above at an oblique angle relative to the surface of the printed circuit board 2, a CCD camera 5 as an imaging means for imaging the irradiated part of the printed circuit board 2, and a control device 6 for execution of various types of control, for image processing, and for calculation processing within the board inspection device 1. In one or more embodiments of the present invention, the control device 6 has an image processing means and a correction calculation means.

The irradiation device 4 is provided with a known liquid crystal optical shutter, and the irradiation device 4 is constructed so as to irradiate the printed circuit board 2 from above in an oblique direction a striped pattern light which varies in phase in increments of ¼ pitch. In one or more embodiments of the present invention, the pattern light is arranged to irradiate along the X axis direction which is parallel to a pair of edges of the rectangular shaped printed circuit board 2. That is, the stripes of the pattern light are irradiated so as to be orthogonal to the X axis direction and parallel to the Y axis direction.

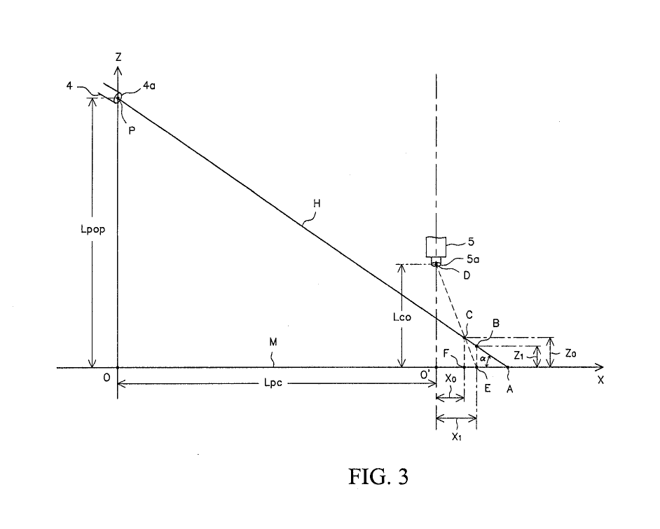

In the irradiation device 4, light from a non-illustrated light source is guided by an optical fiber to a pair of condenser lenses where the light is collimated. This collimated light is transmitted through the liquid crystal element to a projection lens 4a (see FIG. 3) disposed within an isothermal control device. Thereafter, pattern light of four phase variations is irradiated from the projection lens 4a. In this manner, by employing the liquid crystal optical shutter in the irradiation device 4, when striped pattern light is produced, striped pattern light is obtained which has intensities near those of an ideal sine wave. Thus, measurement resolution ability of the three-dimensional measurement can be improved. Further, control of phase shift of the pattern light can be performed electrically, and reduction of size of the control system becomes possible.

The carrying base 3 is provided with motors 15, 16. The motors 15 and 16 are driven and controlled by a control device 6 so that the printed circuit board 2 carried on the carrying base 3 can be moved in an intended direction, e,g., X axis direction and Y axis direction. This configuration makes possible movement of the field of the CCD camera 5, that is, inspection field.

Electrical configuration of the control device 6 will be explained next.

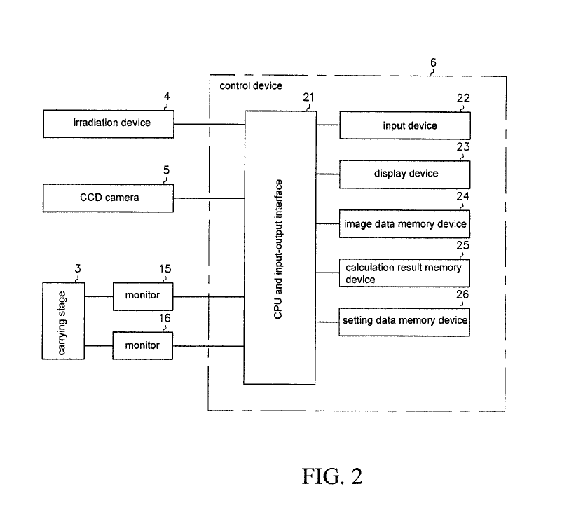

As shown in FIG. 2, the control device 6 includes: a CPU and an input-output interface 21 for overall control of the board inspection device 1; an input device 22 as an “input means” formed by a keyboard and mouse or by a touch panel; a display device 23 as a “display means” having a display screen such as a CRT, liquid crystal display, or the like; an image data memory device 24 for storing image data based on an image from the CCD camera 5; a calculation result memory device 25 for storing various types of calculation results; and a setting data memory device 26 for storage beforehand of various types of data in order to perform the below described calculation processing and the like. These various devices 22 through 26 are each connected electrically to the CPU and the input-output interface 21.

In addition to controlling operation of the irradiation device 4 and initiating irradiation of the pattern light, the control device 6 causes shifting of phase of this pattern light in ¼ pitch increments to perform sequential switching control of four types of irradiation. While irradiation is performed which shifts phase of the pattern light in this manner, the control device 6 also operates and controls the CCD camera 5, the inspection area part is imaged for each type of irradiation, and image data for the four screen parts are obtained.

Then based on the inspection area image data (image data of four screen parts), the control device 6 uses the phase shift method to calculate height data (Z) at each coordinate position (X,Y) within the inspection area. By repetition of the above described processing for each of the pixels, height data (Z) can be obtained for the entire inspection area.

Thereafter, for the coordinate data (X,Y) and height data (Z) obtained in this manner for each position, the control device 6 performs correction calculation processing to correct the distortion which can arise due to field angle of the lens 5a of the CCD camera.

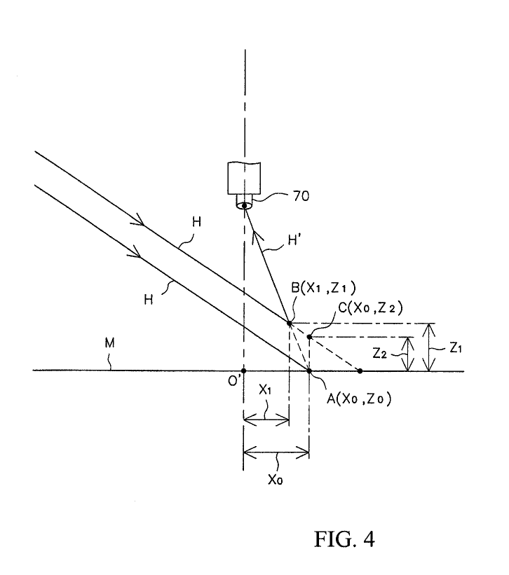

The principles of such correction will be explained below while referring to FIG. 3. The meanings of various labeled points indicated in FIG. 3 are explained below, although the labels here are unrelated to those mentioned in the Background of the Invention and FIG. 4.
P=principle point of the projection lens 4a of the irradiation device 4.
O=point of intersection of the image plane (board standard plane) M and a vertical line passing through the irradiation device 4 (principle point P).
A=point on the image plane M irradiated by a light ray which, within the pattern light irradiated by the irradiation device 4, is the same as a light ray H irradiated on a measurement object point C.
B(X1,Z1)=apparent measurement object point.
C(X0,Z0)=true measurement object point.
D=principle point of the lens 5a of the CCD camera 5.
E=point of intersection of the image plane M and a vertical line passing through the apparent measurement object point B.
F=point of intersection of the image plane M and a vertical line passing through the true measurement object point C.
X0=distance from the image plane center O′ to the intersection point F.
X1=distance from the image plane center O′ to the intersection point E.
Z0=height from the image plane M to the true measurement object point C.
Z1=height from the image plane M to the apparent measurement object point B.
Lpop=height of the principle point P of the projection lens 4a from the image plane M.
Lpc=horizontal direction distance between the principle point D of the lens 5a of the
CCD camera 5 and the principle point P of the projection lens 4a of the irradiation device 4.
Lco=height (CCD camera 5 height data) of the principle point D of the lens 5a of the CCD camera 5 from the image plane M.
α=angle (irradiation angle data) between the image plane M and the light ray H irradiated from the irradiation device 4.

The procedure for finding the calculation formulae (a) and (b) used during correction processing will be explained next.

The below listed formula (1) is derived from the formulae OP/OA=tan(α) and OP=Lpop.

OA=Lpop/tan(α) (1)

The distance OF in the horizontal direction between the irradiation device 4 and the measurement object point C is derived from the below listed formula (2).

OF=Lpc+X0 (2)

Further, because CF/AF=tan(α) and CF=Z0, Z0/(OA−OF)=tan(α). Thus, the below listed formula (3) is derived from Z0=(OA−OF)×tan(α) and the above listed formulae (1) and (2).

Z0=(Lpop/tan(α)−Lpc−X0)×tan(α) (3)

Next, by noticing ΔDO∝ E, it is concluded that Lco/X1=Z0/(X1−X0). Thus the below listed formulae (4) can be derived from (X1−X0)×Lco=Z0×X1.

−X0×Lco=Z0×X1−X1×Lco

X0=(Lco−Z0)X1/Lco

X0=(1−Z0/Lco)×X1 (4)

Further, because formula (3) is substituted into the above listed formulae (4) to obtain the following: Z0={Lpop/tan(α)−Lpc−(1−Z0/Lco)×X1}×tan(α).

The Z0 terms are gathered to give: Z0=Lpop−Lpc×tan(α)−X1×tan(α)+(X1×Z0/Lco)tan(α) and (1−X1×tan(α)/Lco)×Z0=Lpop−(Lpc+X1)tan(α). Since the right side of this equation is equal to Z1, the below listed formula (a) is derived.

Z0=Lco×Z1/(Lco−X1×tan(α)) (a)

The below listed equation (b) is derived by substitution of the above listed formula (a) into formula (4).

X0={1−Z1/(Lco−X1×tan(α))}×X1 (b)

Based on the above listed formulae (a) and (b), the control device 6 is able to calculate the coordinate data X0 and the height data Z0 of the true measurement object point C from the coordinate data X1 and the height data Z1 of the apparent measurement object point B measured from the image data.

In one or more embodiments of the present invention, the CCD camera 5 height data Lco, the irradiation angle α, and the above mentioned formula (a) and (b) required for performing correction are stored prior to measurement in the setting data memory device 26.

The post-correction measurement data (e.g. coordinate data and height data) for each region obtained in this manner are stored in the calculation result memory device 25 of the control device 6. Then based on the measurement data for each such region, the printing range of cream solder higher than the standard plane is detected, and by integration of the heights of each region within this range, the amount of printed cream solder is calculated. Thereafter, comparison determinations are performed between standard data stored beforehand in the setting data memory device 26 and the position, surface area, height, amount, or the like data of cream solder found in this manner. Quality of the printing condition of the cream solder within this inspection area is determined based on whether or not results of such comparison are within permissible ranges.

As described above, according to one or more embodiments of the present invention, measurement accuracy can be improved, and the distortion of measurement data which can arise due to field angle of the lens 5a of the CCD camera 5 can be corrected by software by calculation processing, without use of a telecentric optical system. This has the effect of making possible use of a general macro lens or the like as the lens 5a of the CCD camera 5, and the imaging field can be expanded. Therefore increase in size and complexity of the device can be suppressed, and production cost can be suppressed.

The present invention is not limited to the described details of the above described embodiment, and for example, the following embodiments are also permissible.

(a) Although the above described embodiment adopts the phase shift method as the three-dimensional measurement method, any measurement method may be adopted from among known measurement methods such as the light-section method, space encoding method, focusing method, and the like.

(b) Although in the above described embodiment, a board inspection device 1 which measures height of cream solder printed on a printed circuit board 2 embodies the three-dimensional measuring device, this embodiment is not limiting, and one or more embodiments of the present invention may be configured to measure heights of solder bumps electronic components and the like mounted on the board.

(c) Although the above described embodiment is configured to perform correction calculation processing using the calculation formulae (a) and (b), the calculation formulae are not restricted to these formulae (a) and (b).

Also, the value of the irradiation angle α may be determined directly by measurement of the pattern light or the like. Further, based on the principle of triangulation, the value of the irradiation angle α may be determined indirectly by calculation from the values of the height (Lpop) of the principle point P of the projection lens 4a. In this case, the formula tan(α)=(Lpop−Z1)/(Lpc+X1) may be substituted into the formulae (a) and (b).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A three-dimensional measuring device comprising:
an irradiation means for irradiating a light pattern having a striped light intensity distribution on a measurement object;
an imaging means for imaging reflected light from the measurement object irradiated by the light pattern to obtain image data;
an image processing means for performing measurement of height at various coordinate positions on the measurement object based on the image data imaged by the imaging means; and
a correction calculation means for correction of a distortion that occurs due to a field angle of a lens of the imaging means relative to height data and coordinate data of an measurement object point on the measurement object measured by the image processing means, by correction based on at least a height data of the imaging means and an irradiation angle data of the pattern light irradiated on the measurement object.

2. The three-dimensional measuring device as set forth in claim 1,
wherein the imaging means is disposed directly above the measurement object, and
wherein the irradiation means is disposed obliquely above the measurement object.

3. The three-dimensional measuring device as set forth in claim 2,
wherein height Lco of the principle point of the lens of the imaging means relative to an image plane of the measurement object is used as the height data of the imaging means,
wherein an angle α between the image plane and a light beam of the pattern light irradiated from the irradiation means is used as the irradiation angle data of the pattern light, and
wherein the correction calculation means calculates a true coordinate data X0 and a true height data Z0 of the measurement object point from an apparent coordinate data X1 and an apparent height data Z1 of the measurement object point based on the formulae (a) and (b):
Z0=Lco×Z1/(Lco−X1×tan(α)) (a), and
X0={1−Z1/(Lco−X1×tan(α))}×X1 (b).

4. A three-dimensional measuring device comprising:
an irradiation device that irradiates a light pattern having a striped light intensity distribution on a measurement object;
an imaging device that images reflected light from the measurement object irradiated by the light pattern to obtain image data;
an image processing device that performs measurement of height at various coordinate positions on the measurement object based on the image data imaged by the imaging device; and
a correction calculation device that corrects of a distortion that occurs due to a field angle of a lens of the imaging device relative to height data and coordinate data of an measurement object point on the measurement object measured by the image processing device, by correction based on at least a height data of the imaging device and an irradiation angle data of the pattern light irradiated on the measurement object.

5. The three-dimensional measuring device as set forth in claim 4,
wherein the imaging device is disposed directly above the measurement object, and
wherein the irradiation device is disposed obliquely above the measurement object.

6. The three-dimensional measuring device as set forth in claim 5,
wherein height Lco of the principle point of the lens of the imaging device relative to an image plane of the measurement object is used as the height data of the imaging device,
wherein an angle α between the image plane and a light beam of the pattern light irradiated from the irradiation device is used as the irradiation angle data of the pattern light, and
wherein the correction calculation device calculates a true coordinate data X0 and a true height data Z0 of the measurement object point from an apparent coordinate data X1 and an apparent height data Z1 of the measurement object point based on the formulae (a) and (b):
Z0=Lco×Z1/(Lco−X1×tan(α)) (a), and
X0={1−Z1/(Lco−X1×tan(α))}×X1 (b).

7. A three-dimensional measuring method comprising:
irradiating by an irradiating device a light pattern having a striped light intensity distribution on a measurement object;
imaging by an imaging device reflected light from the measurement object irradiated by the light pattern to obtain image data;
performing measurement of height at various coordinate positions on the measurement object based on the image data to obtain corresponding coordinate data and height data; and
correcting a distortion that occurs due to a field angle of a lens employed in the imaging device relative to height data and coordinate data of an measurement object point on the measurement object, based on at least a height data of the imaging device and an irradiation angle data of the pattern light irradiated on the measurement object.

8. The three-dimensional measuring method as set forth in claim 7, further comprising:
disposing the imaging device directly above the measurement object; and
disposing the irradiation device obliquely above the measurement object.

9. The three-dimensional measuring method as set forth in claim 8,
wherein height Lco of the principle point of the lens of the imaging device relative to an image plane of the measurement object is used as the height data of the imaging device,
wherein an angle α between the image plane and a light beam of the pattern light irradiated from the irradiation device is used as the irradiation angle data of the pattern light, and
wherein a true coordinate data X0 and a true height data Z0 of the measurement object point are calculated from an apparent coordinate data X1 and an apparent height data Z1 of the measurement object point based on the formulae (a) and (b):
Z0=Lco×Z1/(Lco−X1×tan(α)) (a), and
X0={1−Z1/(Lco−X1×tan(α))}×X1 (b).
